(19) United States
(12) Patent Application Publication
(10) Pub. No.: US 2008/0116810 A1
(43) Pub. Date: May 22, 2008

(54) SOLAR THERMOMETER

(76) Inventor: Gary REED, Newmarket (CA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/776,263

(22) Filed: Jul. 11, 2007

Related U.S. Application Data
(60) Provisional application No. 60/859,523, filed on Nov. 17, 2006.

(51) Int. Cl. H05B 37/02; H01M 10/44

(52) U.S. Cl. 315/157

(57) ABSTRACT

A system includes a solar photovoltaic panel, a thermometer and extension conductors coupled between the thermometer and the photovoltaic panel. The thermometer includes a thermometer mechanism responsive to temperature and a control circuit. The control circuit includes a recharge circuit an illumination circuit and at least one LED disposed to illuminate the thermometer. The recharge circuit is coupled to the solar photovoltaic panel through the extension conductors and operable to recharge a rechargeable battery when the photovoltaic panel produces a voltage greater than a predetermined threshold. The illumination circuit is coupled to the rechargeable battery and to the at least one LED, and is operable to energize the at least one LED at a predetermined time. The extension conductors are sufficiently long that the thermometer mechanism is capable of being disposed in a shade area for at least part of the daylight hours while the solar photovoltaic panel is disposed in a sunny area during daylight hours.

### BACKGROUND OF THE INVENTION

### Description of Related Art

Prior solar powered devices include integral photovoltaic panels with the device. However, prior thermometers using known principals would not work well because the thermometer temperature sensor needs to be in the shade to achieve accurate temperature measurement, but the photovoltaic panel needs to be in the sun for optimum energy collection. Prior solar powered devices suffer the disadvantage that the device cannot be disposed in the shade because their integral photovoltaic panels need to be in the sun.

### SUMMARY OF THE INVENTION

A system includes a solar photovoltaic panel, a thermometer and extension conductors coupled between the thermometer and the photovoltaic panel. The thermometer includes a thermometer mechanism responsive to temperature and a control circuit. The control circuit includes a recharge circuit an illumination circuit and at least one LED disposed to illuminate the thermometer. The recharge circuit is coupled to the solar photovoltaic panel through the extension conductors and operable to recharge a rechargeable battery when the photovoltaic panel produces a voltage greater than a predetermined threshold. The illumination circuit is coupled to the rechargeable battery and to the at least one LED, and is operable to energize the at least one LED at a predetermined time. The extension conductors are sufficiently long that the thermometer mechanism is capable of being disposed in a shade area for at least part of the daylight hours while the solar photovoltaic panel is disposed in a sunny area during daylight hours.

### BRIEF DESCRIPTION OF DRAWINGS

The invention will be described in detail in the following description of preferred embodiments with reference to the following figures.

FIG. 1 is a schematic view of a representative embodiment of the solar thermometer in an intended environment.

FIG. 2 is a block diagram of a representative embodiment of the solar thermometer showing component parts.

### DETAILED DESCRIPTION OF PREFERRED EMBODIMENTS

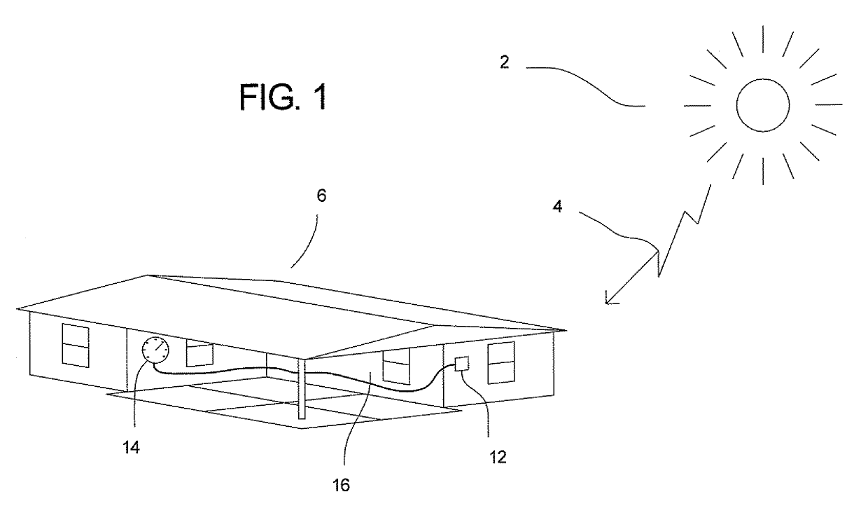

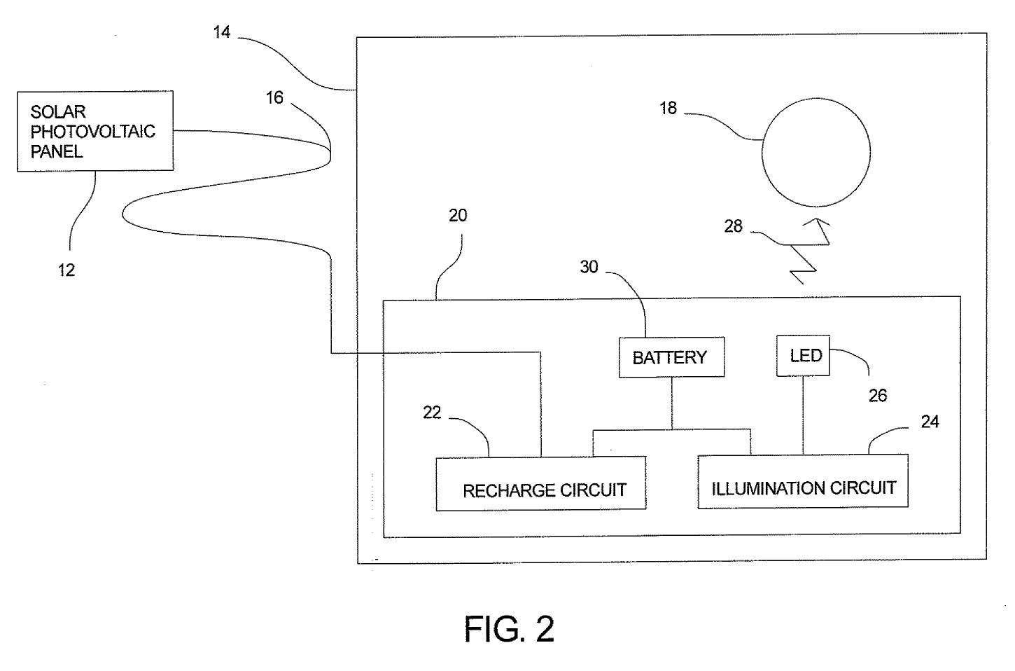

In FIG. 1 a thermometer 14 for use outside of a building 6 (e.g., a house) is preferably kept shaded from sun 2 in order to read correct air temperature. A solar photovoltaic panel 12 is connected to the thermometer 14 by a long conductor pair 16 (e.g., 6 to 10 feet or more) so that the solar panel can be placed in the sun while the thermometer is kept shaded from solar rays 4. In fact, a system includes a solar photovoltaic panel 12, a thermometer 14 and extension conductors 16 coupled between the thermometer and the photovoltaic panel. In FIG. 2, the thermometer 14 includes a thermometer mechanism 18 responsive to temperature and a control circuit 20.

In FIG. 2, the control circuit 20 includes a recharge circuit 22, an illumination circuit 24 and at least one LED 26 disposed to illuminate the thermometer at 28. The recharge circuit (part of the control circuit) is coupled to the solar photovoltaic panel through the extension conductors and is operable to recharge a rechargeable battery 30 when the photovoltaic panel produces a voltage greater than a predetermined threshold. The illumination circuit (also part of the control circuit) is coupled to the rechargeable battery and to the at least one LED and is operable to energize the at least one LED at a predetermined time.

The extension conductors are sufficiently long that the thermometer mechanism is capable of being disposed in a shade area for at least part of the daylight hours while the solar photovoltaic panel is disposed in a sunny area during daylight hours.

In most embodiments, the extension conductors include a conductor for a source of current and a conductor for a current return, and each extension conductor is more than six feet long. In some other embodiments, each extension conductor is more than ten feet long.

In other embodiments the predetermined time commences at a commencement time when the voltage produced by the photovoltaic panel changes from greater than a second predetermined threshold to less than the second predetermined threshold, and the predetermined time ends after the expiration of a predetermined interval after the commencement time. The second predetermined threshold may be different than the predetermined threshold used by the charging circuit, but it may be the same In some embodiments, the predetermined interval is switch selectable. For example, the predetermined interval may be 4 hours after dusk, but a switch may permit the predetermined interval to be selected to be 8 hours after dusk.

In operation, the solar thermometer mainly uses the solar panel as its energy source. When the sun irradiates the solar panel in the daytime, the solar panel transforms the light energy into electricity, then deposits the electricity in the battery As a result, during the night, the battery provides electrical power for the LED of the thermometer. The advantages of this product is economy by using the solar irradiation for the energy source and convenience by extending the utility of a thermometer into nighttime hours, particularly the early nighttime hours when people may still be awake enjoying the evening. The solar thermometer control circuit has been developed specially to compliment the working traits of the solar thermometer. High conversion efficiency (representative value 80-85%), permits this solar thermometer control circuit to reduce the required solar panel power. Since the solar thermometer control circuit is a circuit designed to operate at low voltages (e.g., 0.9V or less), it can use a single section for the secondary battery (0.9-1.4V), for example, a AA rechargeable battery, and the light (e.g., LED) will turn on when the outside rays have faded to a threshold darkness level.

The preferred solar thermometer control circuit has adjustable output current and can operate over a range of supplied input current (e.g., 10-40 mA) and can adapt to various LED applications. In one example, the controller, coupled to a single LED, operates over a range of the input current that varies from 10 to 30 mA and adapts to control all the colors available on a single LED. In another example, the control circuit, coupled to two series connected LEDs, operates over a range of the input current that varies from 10 to 40 mA and adapts to control yellow and green lights. In yet another example, the control circuit, coupled to two parallel connected LEDs, operates over a range of the input current that varies from 10 to 50 mA and adapts to control white, blue and green lights. In still another example, the control circuit, coupled to three parallel connected LEDs, operates over a range of the input current that varies from 10 to 50 mA and adapts to control white, blue and green lights.

An example of a thermometer is a large dial analog thermometer (e.g., 6 or 9 inches in diameter) with a dial face much like a wall clock.

Solar-lighting uses solar energy from solar cells to drive LED (Light-Emitting-Diode) luminescence. The solar energy is stored in the rechargeable battery in daytime and drives the LED in the night. It is safe and easy to use.

Some embodiments use an ANA6601 circuit which is a circuit in a series of Application Specific Integrated Circuits just for Solar-lighting, which is designed by Nanjing ANA Microking Microelectronics Inc. Packaging for ANA6601 is typically either DIP8 or SOP8. Main functions of the circuit include PWM, controller and driver.

Main features include having a high converting efficiency around 80-85%. So the solar cells could be saved. Other features are also having low driving voltage, adjustable output current, etc.

Having described preferred embodiments of a novel solar thermometer (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as defined by the appended claims.

Having thus described the invention with the details and particularity required by the patent laws, what is claimed and desired protected by Letters Patent is set forth in the appended claims.

What is claimed is:

1. A system for operating with a rechargeable battery, the system comprising a solar photovoltaic panel, a thermometer and extension conductors coupled between the thermometer and the photovoltaic panel, wherein:
the thermometer includes a thermometer mechanism responsive to temperature and a control circuit;
the control circuit includes a recharge circuit, an illumination circuit and at least one LED disposed to illuminate the thermometer;
the recharge circuit is coupled to the solar photovoltaic panel through the extension conductors and operable to recharge a rechargeable battery when the photovoltaic panel produces a voltage greater than a predetermined threshold;
the illumination circuit is coupled to the rechargeable battery and to the at least one LED, and is operable to energize the at least one LED at a predetermined time; and
the extension conductors are sufficiently long that the thermometer mechanism is capable of being disposed in a shade area for at least part of the daylight hours while the solar photovoltaic panel is disposed in a sunny area during daylight hours.

2. A system according to claim 1, wherein:
the extension conductors include a conductor for a source of current and a conductor for a current return; and
each extension conductor is more than six feet long.

3. A system according to claim 2, wherein each extension conductor is more than ten feet long.

4. A system according to claim 1, wherein:
the predetermined time commences at a commencement time when the voltage produced by the photovoltaic panel changes from greater than a second predetermined threshold to less than the second predetermined threshold; and
the predetermined time ends after the expiration of a predetermined interval after the commencement time.

5. A system according to claim 4, wherein the predetermined interval is switch selectable.
